(19) United States
(12) Patent Application Publication
(10) Pub. No.: US 2025/0332508 A1
(43) Pub. Date: Oct. 30, 2025

(54) GAME DASHBOARD

(71) Applicant: Google LLC, Mountain View, CA (US)

(72) Inventors: Devika Rajiv Lal, San Francisco, CA (US); Joseph Lee Pang, Los Altos, CA (US); Prameet H Shah, Campbell, CA (US); Gina Marie Domergue, Oakland, CA (US); Cuicui Ruan, San Jose, CA (US)

(21) Appl. No.: 19/170,591

(22) Filed: Apr. 4, 2025

Related U.S. Application Data
(60) Provisional application No. 63/638,622, filed on Apr. 25, 2024.

(51) Int. Cl. A63F 13/533; A63F 13/497; A63F 13/60

(52) U.S. Cl. CPC A63F 13/533; A63F 13/60; A63F 13/497

(57) ABSTRACT

The application relates to the generation of a game dashboard as an overlay on a game window. The generation may include observing, by one or more processors of a client computing device, one or more generated windows on a display of the client computing device, the one or more generated windows corresponding to one or more active applications; obtaining, by the one or more processors, an indicator corresponding to a window of interest of the one or more generated windows; determining, by the one or more processors based on the indicator, whether an application corresponding to the window of interest is a game; generating, by the one or more processors, game dashboard context for the window of interest based on the game determination; and generating, by the one or more processors, the game dashboard as an overlay in the window of interest based on the game dashboard context.

### CROSS-REFERENCE TO RELATED APPLICATIONS

This application claims the benefit of and priority to U.S. Provisional Patent Application No. 63/638,622, filed Apr. 25, 2024, the entire disclosure of which is incorporated by reference herein.

### BACKGROUND

Users can access games from multiple sources on local devices. Each source may be directed towards a particular device, style of gameplay, etc. Such a variety of games from multiple sources may lead to limited functionality due to incompatibility of a game and device. For example, games designed to operate on one device or platform may not be able to operate smoothly or in the same manner on a different device, configuration or platform. Even if a game is capable of running on multiple platforms, a technical problem may be that some functionality is lost due to incompatible user interfaces.

### BRIEF SUMMARY

Aspects of the technology provide a technical solution that enables a consistent gaming experience for users. In this regard, aspects of the technology allow for functionality of each game to be maintained regardless of a game's original source. The interface disclosed herein provides a single, unified gaming experience for all users. By way of example, this includes a user interface (e.g., game dashboard) that allows a user to access both features specific to each game, along with universally enabled features that support and enable gameplay while minimizing potential distractions. This provides a technical benefit by enabling a consistent and supported gaming experience for users without need to play a game on its original intended device or operating system (OS). Such a technical benefit is particularly advantageous for a device and/or OS with no or few native applications or games.

According to one aspect, a method of generating a game dashboard, the method includes: observing, by one or more processors of a client computing device, one or more generated windows on a display of the client computing device, the one or more generated windows corresponding to one or more active applications; obtaining, by the one or more processors, an indicator corresponding to a window of interest of the one or more generated windows; determining, by the one or more processors based on the indicator, whether an application corresponding to the window of interest is a game; generating, by the one or more processors, game dashboard context for the window of interest based on the game determination; and generating, by the one or more processors, the game dashboard as an overlay in the window of interest based on the game dashboard context.

In some examples, the method may further comprise determining, by the one or more processors, whether at least one of the one or more generated windows is a window of interest. The window of interest is a plurality of windows of interest. In some instances, the indicator may be an application identification of an application corresponding to the window of interest, and the application identification may be obtained via a string check. In some instances, the indicator may be a category of an application corresponding to the window of interest, and the category may be obtained from a source of the application corresponding to the window of interest.

In some instances, the game dashboard context may include information relevant to the generation of the game dashboard as an overlay, and the game dashboard context may be unique to the window of interest.

In some instances, the game dashboard may include an entry point. The entry point may be configured to allow a user to interact with one or more features. The one or more features may be unique to the window of interest. Additionally or alternatively, the one or more features may be selected by at least one of i) a user and ii) an application developer. Additionally or alternatively, the method may further include determining, by the one or more processors, the one or more features based on the application corresponding to the window of interest.

### BRIEF DESCRIPTION OF DRAWINGS

FIG. 1 illustrates a client computing device in accordance with aspects of the technology.

FIG. 2 is a block diagram of a client computing device in accordance with aspects of the technology.

FIG. 3A illustrates a system for use with aspects of the technology.

FIG. 3B illustrates a system for use with aspects of the technology.

FIG. 4 illustrates an example method in accordance with aspects of the technology.

FIG. 5 illustrates an example game dashboard overlay in accordance with aspects of the technology.

FIG. 6 illustrates aspects of an example game dashboard overlay in accordance with aspects of the technology.

FIGS. 7A-7C illustrate example game window configurations in accordance with aspects of the technology.

### DETAILED DESCRIPTION

### Overview

Aspects of the technology provide a technical solution that enables a consistent gaming experience for users. In this regard, aspects of the technology allow for functionality of each game to be maintained regardless of a game's original source. The interface disclosed herein provides a single, unified gaming experience for all users. By way of example, this includes a game dashboard that allows a user to access both features specific to each game, along with universally enabled features that support and enable gameplay while minimizing potential distractions.

One or more processors of a processing module a client computing device may be configured to run one or more programs (e.g., applications, games, etc.). According to one aspect of the technology, games may be retrieved from differing sources (e.g., memory module, a remote device or server as a progressive web app (PWA) or another remotely-hosted app, database, etc.). While running the game(s), the one or more processors may be configured to generate and overlay a game dashboard in each game window of the corresponding game. Each game window may be generated by the one or more processors and displayed on a display of the client computing device via a graphical user interface (GUI). Only one game dashboard may be generated on each game window.

In the generation of the game dashboard on a game window, the one or more processors may first determine whether a given application is a game, the application corresponding to a displayed window. In this regard, the one or more processors may observe one or more generated windows corresponding to one or more active (e.g., currently running) applications. The observation may commence following the generation or initialization of the one or more windows.

The generation of the game dashboard may further include obtaining, by the one or more processors, an indicator corresponding to a window of interest of the one or more generated windows and determining, by the one or more processors based on the indicator, whether an application corresponding to the window of interest is a game. In this regard, the observation may further include the one or more processors obtaining an indicator corresponding to the determined window of interest and determining, based on the indicator, whether the application corresponding to the window of interest is a game. The window of interest may be a window that is at the forefront of the display of the client computing device.

The generation of the game dashboard may further include generating, by the one or more processors, game dashboard context for the window of interest based on the game determination; and generating, by the one or more processors, the game dashboard as an overlay in the window of interest based on the game dashboard context. In this regard, in the generation of the game dashboard on a game window, the one or more processors may generate game dashboard context for that game window. The game dashboard may be generated using the game dashboard context. A game window may be a window determined to be a window of interest, with a corresponding application thereof determined to be a game. The game dashboard context may include information relevant to the generation of the game dashboard as an overlay. The game dashboard context may be unique to the game window.

The game dashboard may include a game dashboard menu. The game dashboard menu may include one or more tiles, one or more feature settings, and/or a dashboard cluster. The game dashboard may further include an entry point. The game dashboard may further include a toolbar including one or more quick actions.

The game dashboard menu may allow a user to interact with the one or more tiles, the one or more feature settings, and/or the dashboard cluster. The entry point may allow a user to interact with the game dashboard menu. The one or more tiles of the game dashboard menu are configured to allow the user to interact with one or more features. The interaction may include changing a state of the feature and/or changing an appearance of the one or more tiles. The interaction may be via one of the one or more user units, such as, for example, user inputs of user input section. The one or more feature settings may be a list of one or more feature settings corresponding to features of the game dashboard. The one or more features settings may allow a user to toggle features on and off, toggle between different settings of the features, etc. Additionally or alternatively, the listed one or more features settings may open sub-menu that allow for modification of one or more features.

The dashboard cluster may include one or more items the user may interact with or provide information thereto. For example, the dashboard cluster may include a feedback option, help option, settings option, and/or a system time (e.g., time consistent with a time zone of the computing device). The toolbar may allow a user to interact with one or more features, such as those corresponding to the one or more quick actions, without pausing and/or leaving game play. The toolbar may be collapsable. In this regard, a user may collapse or make the toolbar smaller by interacting with one of the one or more quick actions. The one or more quick actions may correspond to the features of the one or more tiles or one or more feature settings as discussed above.

Unless otherwise stated, the disclosed examples and scenarios are not mutually exclusive, but may be implemented in various combinations to achieve unique advantages. As these and other variations and combinations of the features discussed above can be utilized without departing from the subject matter defined by the claims, the description of the implementations should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

### EXAMPLE SYSTEMS

### Example Computing Device

The following discusses examples of computing devices which may be used in conjunction with the technology presented herein. These examples are not intended to limit the scope of the technology.

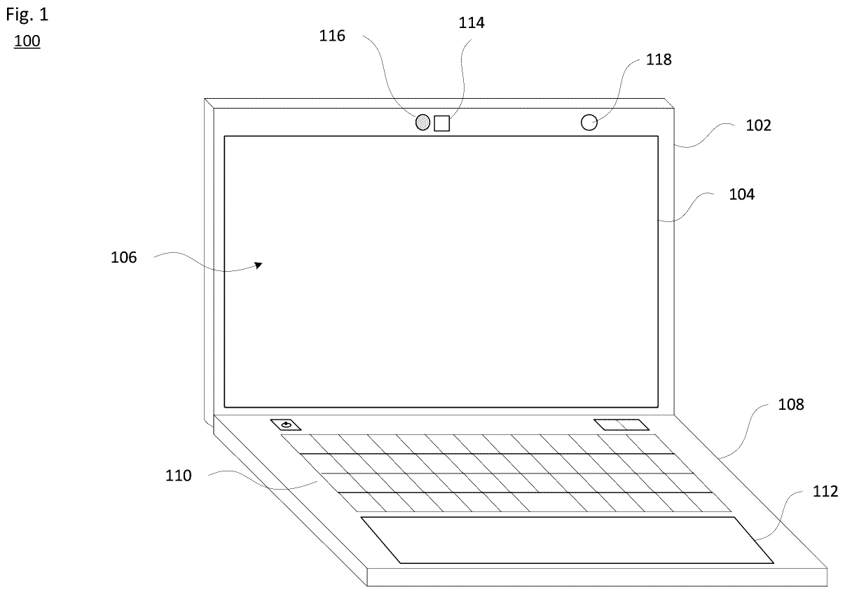

FIG. 1 illustrates an example 100 showing a client computing device 102, such as a laptop computer. In this example, there is a display 104 for visually presenting content via a graphical user interface (GUI) 106, and a user input section 108 having a keyboard 110 and a trackpad 112 as different user inputs. A microphone (not shown) may be provided for audible input. The display 104 may be configured as a user input (e.g., a touchscreen). The keyboard 110 may be a virtual keyboard, for instance as part of another display. While one trackpad 112 is shown, the device may have two or more trackpads arranged thereon. The device may contain additional user inputs (e.g., a mouse, audio and/or gesture-based inputs).

An integrated webcam 114 can be used for videoconferences, interactive gaming, etc. Indicator 116, such as an LED, may be illuminated to alert a user whenever the integrated webcam is in use. The client computing device may also include one or more other sensors 118, which may be used to supplement visual information obtained by the webcam 114. By way of example, the one or more other sensors may include an additional imaging device, an RF—or ultrasonic-based motion sensor, such as to help identify gestures by the user or act as a human presence detector.

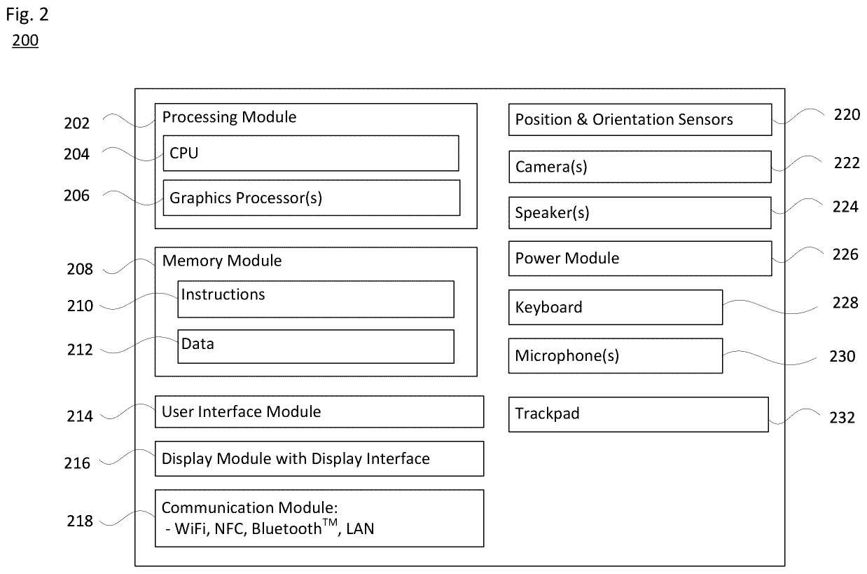

FIG. 2 illustrates a block diagram of an example client computing device 200, such as the laptop shown in FIG. 1 (e.g., a tablet PC or netbook), a desktop PC, an in-home device such as a smart display, or the like. As shown, the client computing device 200 includes a processing module 202 having one or more computer processors such as a central processing unit 204 and/or graphics processors 206, as well as memory module 208 configured to store instructions 210 and data 212. The processors may or may not operate in parallel, and may include ASICs, controllers, and other types of hardware circuitry. The processors are configured to receive information from a user through user interface module 214, and to present information to the user on one or more display devices of the display module 216 having a display interface.

User interface module 214 may receive commands or other input information from a user via user inputs and convert them for submission to a given processor. The user interface module may link to applications executable by the client computing device's processing module 202. The user inputs may include one or more of a touchscreen, keypad, trackpad, stylus, microphone, mouse, or other types of input devices. The display module 216 may comprise appropriate circuitry for driving the display device to present graphical and other information to the user. By way of example, the graphical information may be generated by the graphics processor(s) 206, while the central processing unit (CPU) 204 manages overall operation of the client computing device 200. The graphical information may display responses to user queries or other content on the display module 216. For instance, the processing module may run a browser application, messaging application or other service using instructions and data stored in memory module 208, and present information associated with the browser application or other service to the user via the display module 216. The memory module may include a database or other storage for application-related information, etc.

Memory module 208 can be implemented as one or more of a computer-readable medium or media, a volatile memory unit or units, or a non-volatile memory unit or units. The memory module 208 may include, for example, flash memory and/or NVRAM, and may be embodied as a hard-drive or memory card. Alternatively or additionally, the memory module 208 may also include removable media (e.g., DVD, CD-ROM or USB thumb drive). One or more regions of the memory module 208 may be write-capable while other regions may comprise read-only (or otherwise write-protected) memories. In one implementation, a computer program product is tangibly embodied in an information carrier. Although FIG. 2 functionally illustrates the processor(s), memory module, and other elements of client computing device 200 as being within the same overall block, such components may or may not be stored within the same physical housing. For example, some or all of the instructions and data may be stored on an information carrier that is a removable storage medium (e.g., optical drive, high-density tape drive or USB drive) and others stored within a read-only computer chip.

The data 212 may be retrieved, stored, or modified by the processors in accordance with the instructions 210. For instance, the data may be stored in computing device registers, in a relational database as a table having a plurality of different fields and records, XML documents or flat files. The data may also be formatted in any computing device-readable format.

The instructions 210 may be any set of instructions to be executed directly (such as machine code) or indirectly (such as scripts) by the processor(s). For example, the instructions may be stored as computing device code on the computing device-readable medium. In that regard, the terms “instructions” and “programs” may be used interchangeably herein. The instructions may be stored in object code format for direct processing by the processor(s), or in any other computing device language including scripts or collections of independent source code modules that are interpreted on demand or compiled in advance.

As also shown in FIG. 2, the client device 200 includes a communication module 218 for communicating with other devices and systems, including other client devices, servers and databases. The communication module 218 includes a wireless transceiver; alternatively, the module may alternatively or additionally include a wired transceiver. The client device 200 may communicate with other remote devices via the communication module 218 using various configurations and protocols, including short range communication protocols such as near-field communication (NFC), Bluetooth™, Bluetooth™ Low Energy (BLE) or other ad-hoc networks, the Internet, intranets, virtual private networks, wide area networks, local networks, private networks using communication protocols proprietary to one or more companies, Ethernet, WiFi and HTTP, and combinations of the foregoing.

The example client device 200 as shown also includes one or more position and orientation sensors 220. The position and orientation sensors 220 are configured to determine the position and orientation of one or more parts of the client computing device 200. For example, these components may include a GPS receiver or other global positioning component to determine the device's latitude, longitude and/or altitude as well as an accelerometer, gyroscope or another direction/speed detection device such as an inertial measurement unit (IMU). The client device 200 may also include one or more camera(s) 222 for capturing still images and recording video streams such as the integrated webcam as discussed above, speaker(s) 224. Power module 226 provides power to the various system components. In addition, user inputs include a keyboard 228 and a microphone 230, which may comprise a microphone array having one or more transducers or other microphone elements distributed at various points along the housing of the computing device. Trackpad 232 may include either a capacitive touch sensor unit or a piezoelectric sensor unit (or both).

### Example Network

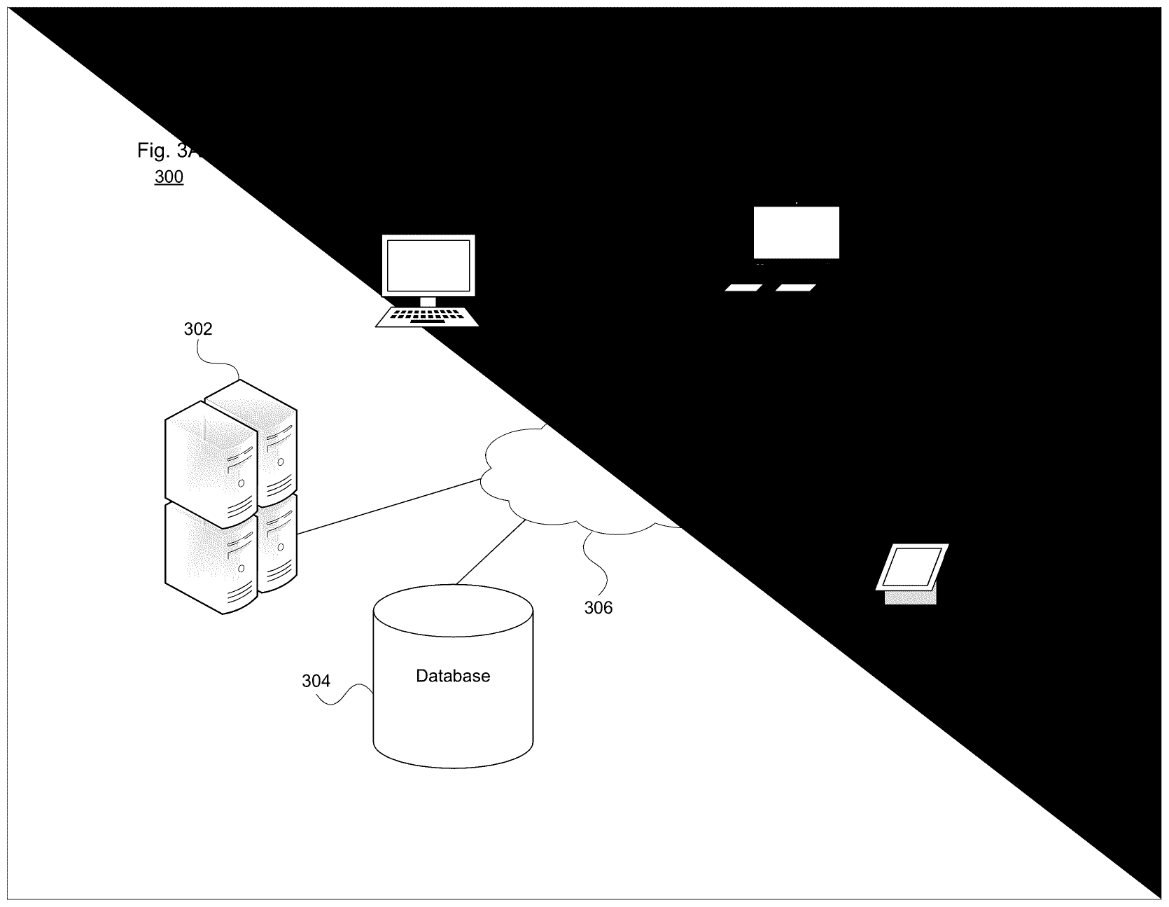

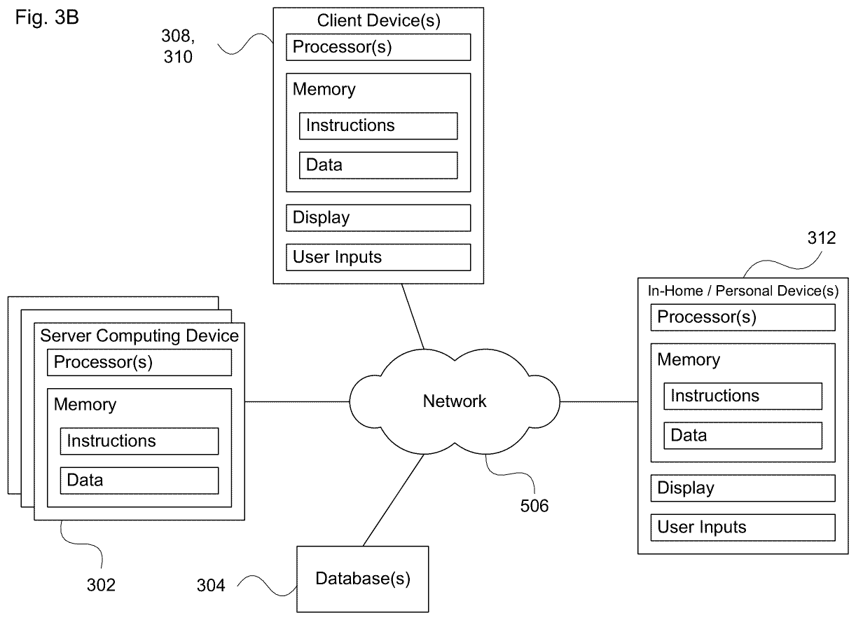

One or more devices (e.g., including client computing device 102, 200) may connect to one another over a network. FIGS. 3A and 3B are pictorial and functional diagrams, respectively, of an example system 300 that includes a plurality of computing devices and databases connected via a network. For instance, computing device(s) 302 may be a cloud-based server system that provides or otherwise supports one or more programs (e.g. applications, games, etc.). Database 304 may store game data, user profile information, and/or other information. The server system may access the databases via network 306. Client devices may include one or more of a desktop computer 308, a laptop or tablet PC 310 and in-home devices such as smart display 312.

In one example, computing device 302 may include one or more server computing devices having a plurality of computing devices, e.g., a load balanced server farm or cloud computing system, that exchange information with different nodes of a network for the purpose of receiving, processing, and transmitting the data to and from other computing devices. For instance, computing device 302 may include one or more server computing devices that are capable of communicating with any of the computing devices 308-312 via the network 306.

As shown in FIG. 3B, each of the computing devices 302 and 308-312 may include one or more processors, memory, data and instructions. The memory stores information accessible by the one or more processors, including instructions and data that may be executed or otherwise used by the processor(s). The memory may be of any type capable of storing information accessible by the processor(s), including a computing device-readable medium. The memory is a non-transitory medium such as a hard-drive, memory card, optical disk, solid-state, etc. Systems may include different combinations of the foregoing; whereby different portions of the instructions and data are stored on different types of media. The instructions may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance.

The processors may be any conventional processors, such as commercially available CPUs. Alternatively, each processor may be a dedicated device such as an ASIC, graphics processing unit (GPU), tensor processing unit (TPU) or other hardware-based processor. Although FIG. 3B functionally illustrates the processors, memory, and other elements of a given computing device as being within the same block, such devices may actually include multiple processors, computing devices, or memories that may or may not be stored within the same physical housing. Similarly, the memory may be a hard drive or other storage media located in a housing different from that of the processor(s), for instance in a cloud computing system of server 302. Accordingly, references to a processor or computing device will be understood to include references to a collection of processors or computing devices or memories that may or may not operate in parallel.

The computing devices may include all of the components normally used in connection with a computing device such as the processor and memory described above as well as a user interface subsystem for receiving input from a user and presenting information to the user (e.g., text, imagery and/or other graphical elements). The user interface subsystem may include one or more user inputs (e.g., at least one front (user) facing camera, a mouse, keyboard, touchscreen and/or microphone) and one or more display devices that operable to display information (e.g., text, imagery and/or other graphical elements). Other output devices, such as speaker(s) may also provide information to users.

The user-related computing devices (e.g., 308-312) may communicate with a back-end computing system (e.g., server 302) via one or more networks, such as network 306. The network 306, and intervening nodes, may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Reference to “one or more processors” herein includes situations where a set of processors (e.g., two or more CPUs, TPUs, GPUs or any combination thereof) may be configured to perform one or more operations. Any combination of such a set of processors may perform individual operations or a group of operations. Therefore, reference to “one or more processors” does not require that all processors in the set must perform all of the operations. Rather, unless expressly stated, any one (or different combinations) of the one or more processors may perform different operations when a set of operations is indicated. For instance, different processors may perform specific operations.

### Example Methods

### Game Dashboard Generation

As discussed above, the one or more processors of the processing module 202 of the client computing device 102, 200 may be configured to run one or more programs (e.g., applications, games, etc.). According to one aspect of the technology, games may be retrieved from differing sources (e.g., memory module 208, a remote device or server 302 as a progressive web app (PWA) or another remotely-hosted app, database 304, etc.). While running the game(s), the one or more processors may be configured to generate and overlay a game dashboard in each game window of the corresponding game. Each game window may be generated by the one or more processors and displayed on the display 104 of the client computing device 102, 200 via the GUI 106. In one example, each game window of the one or more games may be displayed on the display 104 via the GUI 106. Only one game dashboard may be generated on each game window.

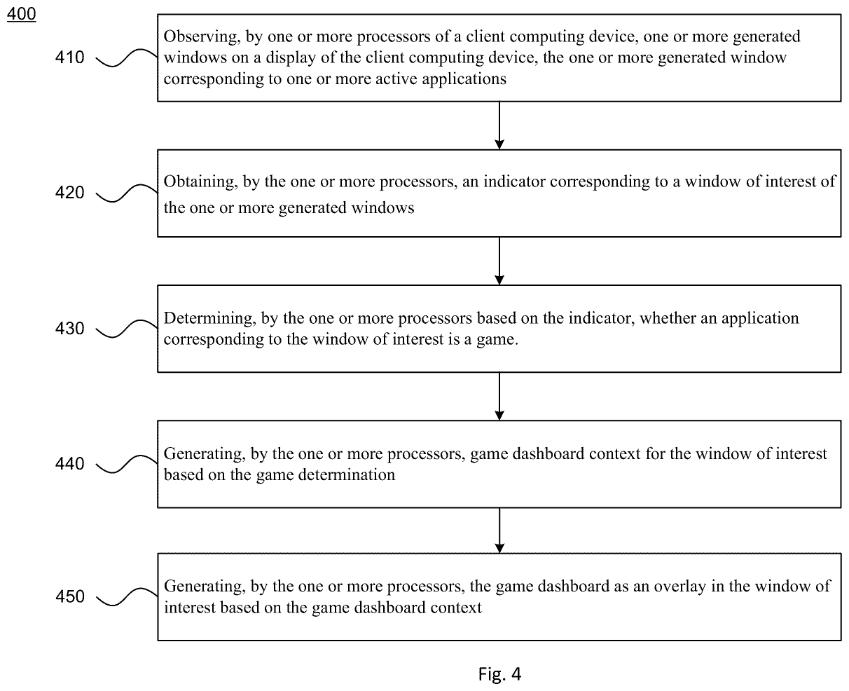

FIG. 4 shows an example method 400 of generating a game dashboard. In the generation of the game dashboard on a game window, the one or more processors may first determine whether a given application is a game, the application corresponding to a displayed window. For example, at block 410, the method 400 includes observing, by one or more processors of a client computing device, one or more generated windows on a display of the client computing device, the one or more generated window corresponding to one or more active applications. In this regard, the one or more processors may observe one or more generated windows corresponding to one or more active (e.g., currently running) applications. The observation may commence following the generation or initialization of the one or more windows. In some instances, the observation may include determining that one of the one or more windows is a window of interest. The one or more processors may determine one of the one or more windows is the window of interest by further determining which of the one or more windows is at the forefront of the display 104 of the client computing device 102, 200. The forefront determination may include determining that one of the one or more windows is open or viewable on the display 104 and in front of other open windows. Upon determining a window is at the forefront of the display 104, the one or more processors may determine the open window is a window of interest. In some instances, the window of interest may be a plurality of windows of interest. In one scenario, the plurality of windows of interest may be generated on a single display 104 (e.g., a single monitor) wherein each of the plurality of windows are at the forefront of the display 104. In another scenario, the plurality of windows of interest may be generated on a plurality of displays (e.g., a plurality of monitors).

At blocks 420 and 430, the method 400 further includes, obtaining, by the one or more processors, an indicator corresponding to a window of interest of the one or more generated windows and determining, by the one or more processors based on the indicator, whether an application corresponding to the window of interest is a game. In this regard, the observation may further include the one or more processors obtaining an indicator corresponding to the determined window of interest and determining, based on the indicator, whether the application corresponding to the window of interest is a game. By way of example, the indicator may be indicative of an application type. In some instances, the indicator may be an application identification of the application corresponding to the determined window of interest. The application identification may be asynchronously initialized and may not change throughout the operation of the application corresponding to the determined window of interest. The obtained application identification may be compared to a set of one or more known game identifications. When a match is found, the application corresponding to the window of interest is determined to be a game. In some instances, the application identification may be unique to each window, including the window of interest. In some instances, the application identification may be obtained via a string check.

In some instances, the indicator may be a category of the application corresponding to the determined window of interest. The category may be retrieved from the source (e.g., platform) of the application). When the retrieved category is a game, the application corresponding to the window of interest is determined to be a game. Following the determination that the window of interest is a game, the one or more processors may store the result thereof in the memory module 208 of the client computing device 102, 200.

In some instances, the one or more processors may continue to observe the one or more windows while open. In this regard, the one or more processors may repeat one or more of the above steps of the observation. The repetition may occur periodically and/or when one of the one or more windows is closed (e.g., minimized, operation of the corresponding application is terminated, etc.). Alternatively, the one or more processors may stop observing the windows that are not the determined window(s) of interest.

At blocks 440 and 450, the method 400 further includes generating, by the one or more processors, game dashboard context for the window of interest based on the game determination; and generating, by the one or more processors, the game dashboard as an overlay in the window of interest based on the game dashboard context. In this regard, in the generation of the game dashboard on a game window, the one or more processors may generate game dashboard context for that game window. The game dashboard may be generated using the game dashboard context. A game window may be a window determined to be a window of interest, with a corresponding application thereof determined to be a game. In some instances, when the window of interest is a plurality of windows of interest, a game dashboard may be generated for each window of interest. In such an instance, an entry point (discussed in further detail below) of the game dashboard may be viewable on each of the plurality of windows of interest and a game dashboard menu (discussed in further detail below) of the game dashboard may only be viewable on one of the plurality of windows of interest. For example, the plurality of windows of interest may be a first window of interest and a second window of interest. The first window of interest may include both an entry point and a game dashboard menu while the second window may only include an entry point. The second window may include a game dashboard menu when a user interacts with the entry point thereof. Following user interaction with the entry point on the second window, the game menu on the first window may be closed.

The game dashboard context may include information relevant to the generation of the game dashboard as an overlay. The game dashboard context may be unique to the game window. In this regard, generated game dashboards may include features (discussed in more detail below) or specifications unique to a game window. In one example, the specifications may include scaling of the game dashboard overlay. In another example, the game dashboard context may be indicative of or allow for the generation of features that are relevant to the underlying game of the game window. In some instances, the relevant features may be selected by a user, a game developer, or a combination thereof. Additionally or alternatively, the relevant features may be determined based on the type of game. The type of game may be related to the source of the game, the original intended device of the game, the original intended OS of the game, or any combination thereof. In this regard, the one or more processors of the client computing devices may make an informed choice or determination of what features (e.g., touch compatibility, video record, screenshot, etc.) are suitable for a given game. In some instances, the informed choice or determination may be based on a device type of the client computing device. Device type may include the device specifications such as the software and/or hardware of the device. In some instances the device type may be indicative of what features may be supported by the client computing device. In some instances, the informed choice or determination may be based on if a user is subscribed or has been granted access to a particular feature.

In some instances, the game dashboard context may be deleted when the game window is closed. The one or more processors may be configured to hold state of the game window or continue to observe the game window for changes. In this regard, the one or more processors may modify the game context as the game window changes. Changes to the game window may include changes to the bounds thereof, and or the current screen view of the game (e.g., windowed, maximized, fullscreen as discussed below).

In some instances, the one or more processors may determine that there is no window of interest and not generate game dashboard context or the game dashboard. In such an instance, there may be no window of interest when the client computing device is in a mode allowing for simultaneous view mode of all open windows. For example, a view mode may be an overview mode. The overview mode may show all open windows on screen together to allow for switching therebetween. The overview mode may not allow typical or functional interaction with the open windows. In a further example, a view mode may be a list mode. The list mode may show all open windows on screen as a scrollable list to allow for switching therebetween. The overview mode may not allow typical or functional interaction with the open windows.

In some instances, the one the one or more processors may determine that the window of interest is not a game and not generate game dashboard context or the game dashboard. In such an instance, the window of interest may be an application that does not correspond to a game.

### Example Game Dashboard

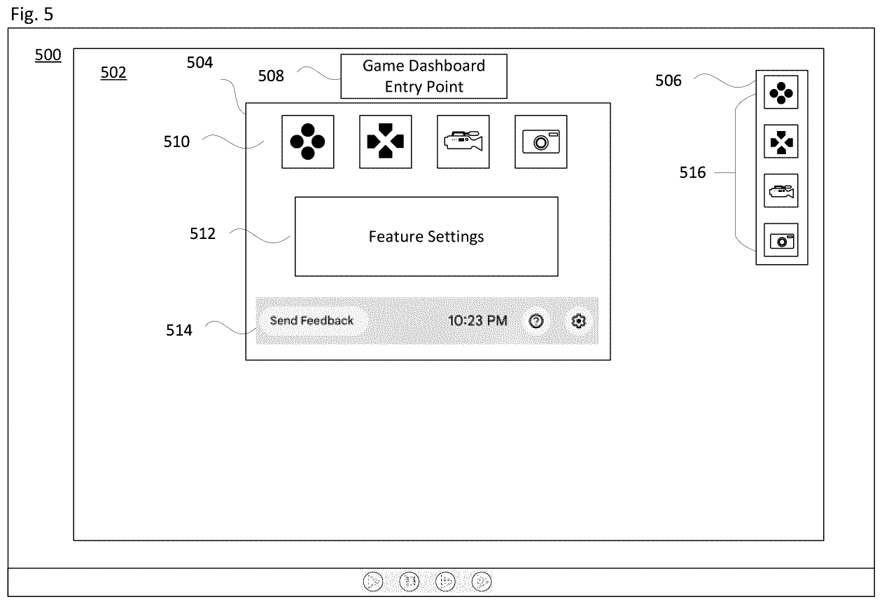

FIG. 5 illustrates an example of a game dashboard overlayed on a game window 502 as may be presented on a display 500 via a GUI of the client computing device. The game window 502 of the game is generated and displayed on the display 500 of a client computing device. The game dashboard includes a game dashboard menu 504. In this scenario, the game dashboard menu 504 includes one or more tiles 510, one or more feature settings 512, and a dashboard cluster 514. The game dashboard further includes the entry point 508. The game dashboard further includes a toolbar 506 including one or more quick actions 516.

The game dashboard menu 504 may allow a user to interact with the one or more tiles 510, the one or more feature settings 512, and/or the dashboard cluster 514. The interaction may be via one or more user inputs of the client computing device. The gameplay may be temporarily paused and/or left while a user interacts with the game dashboard menu 504.

The entry point 508 may allow a user to interact with the game dashboard menu 504. In this regard, a user may interact with the entry point 508 via one or more user inputs of the client computing device. Based on the interaction, the one or more processors may generate the dashboard menu on the game window 502.

The one or more tiles 510 of the game dashboard menu 504 are configured to allow the user to interact with one or more features. The interaction may include changing a state of the feature and/or changing an appearance of the one or more tiles. The interaction may be via one of the one or more user units, such as, for example, user inputs of user input section 108.

Example features may include, e.g., visibility of the toolbar 506, visibility of game controls, gameplay recording, and gameplay screenshot. The one or more tiles 510 may be a plurality of tiles and include more than one of these features, features not expressly mentioned, or a combination thereof. The features of the one or more tiles 510 may be common across all game windows including the game dashboard overlay or vary based on underlying game. The features of the one or more tiles 510 may be modified by, for example by the user, to add and subtract desired features.

As discussed above, the features of the one or more tiles 510 may be unique to a game window and underlying game. In one example, features may be relevant to the underlying game of the game window. In some instances, the relevant features may be selected by a user, a game developer, or a combination thereof. Additionally or alternatively, the relevant features may be determined based on the type of game. The type of game may be related to the source of the game, the original intended device of the game, the original intended OS of the game, or any combination thereof. In this regard, the one or more processors of the client computing devices may determine what features (e.g., touch compatibility, video record, screenshot, etc.) can be included for a given game. In some instances, aspects of the features may be determined on a per-game basis. In this regard, the features may be conformed to the specification of a particular game.

In one example, the one or more tiles may 510 include the visibility of the toolbar 506 feature. Here, the user may interact with this feature to toggle the visibility of toolbar 506. In this regard, the toolbar 406 may appear faded, translucent, or not be generated in the game window 502 when the user deactivates the tile corresponding to the feature. When the user activates the tile, the toolbar 506 may be sold in color, be generated in the game window 502, and/or allow the user to interact therewith. Additionally, the appearance of the tile of the one or more tiles 510 corresponding to the visibility of toolbar 506 feature may differ based on the state of the feature. In this regard, when the feature is toggled on or activated, the corresponding tile may be solid in color. When the feature is toggled off or deactivated, the corresponding tile may appear more translucent. Additionally or alternatively, the color of the tile corresponding to the feature may be a different color when toggled on and off respectively. In some instances, the colors (e.g., the original and different color) may be selected by a user. In such an instance, the colors may correspond to the color scheme of the OS of the client computing device. In some instances, activation may be the default state prior to any user interaction. Alternatively, deactivation may be the default state prior to any user interaction.

In a further example, the one or more tiles 510 may include the visibility of game controls. In such an example, a user may interact with this feature to toggle the visibility of game controls. In this regard, the game controls may appear faded, translucent, or not be generated in the game window 502 when the user deactivates the tile corresponding to the feature. When the user activates the tile, the game controls may be generated in the game window 502. The game controls may include a labeled diagram or mapping of what user inputs correspond to actions/features of the game. Additionally, the appearance of the tile of the one or more tiles 510 corresponding to the visibility of toolbar 506 feature may differ based on the state of the feature. In this regard, when the feature is toggled on or activated, the corresponding tile may be solid in color. When the feature is toggled off or deactivated, the corresponding tile may appear more translucent. Additionally or alternatively, the color of the tile corresponding to the feature may be a different color when toggled on and off respectively. In some instances, the colors (e.g., the original and different color) may be selected by a user. In such an instance, the colors may correspond to the color scheme of the OS of the client computing device. In some instances, activation may be the default state prior to any user interaction. Alternatively, deactivation may be the default state prior to any user interaction.

In a further example, the one or more tiles 510 may include the gameplay recording feature. In such an example, a user may stop and start recording of current gameplay in the game window 502. The recording may include game visuals generated on the game window 502 and accompanying audio associated with gameplay. In some instances, the recording may exclude the game dashboard overly (e.g., the game dashboard menu 504, the entry point 508, and/or the toolbar 506). In some instances, the recording may additionally or alternatively include a video and audio recording of the user playing the game. Such a recording may be collected via the one or more user inputs (e.g., camera, integrated webcam, one or more microphones, etc.).

In such an example, a user may start or otherwise launch the gameplay recording feature by interacting with the corresponding tile. When the recording commences, the corresponding tile may change in appearance. In this regard, the tile may display an indication that a recording is in progress. The indication may be a change in color (to e.g., red from green), a display of a recording time, and/or change of a displayed message or text. The user may interact with the tile again to terminate the recording. When the recording stops, the corresponding tile may change in appearance. In this regard, the tile may change in color, shading or via some other indicia, display a total recording time, and/or change a displayed message or text. In some instances, the colors (e.g., the original and different color) may be selected by a user. In such an instance, the colors may correspond to the color scheme of the OS of the client computing device. In some instances, the stop recording interaction may function as a path to an outside application. The outside application may allow the user to save the recording, log into an outside application (e.g., social media) and upload the recording thereto, or both. When logging into an outside application, a submenu may be generated. The submenu may be the login form of the outside application.

In a further example, the one or more tiles 510 may include the gameplay screenshot feature. In such an example, a user may initiate a screenshot of current gameplay in the game window 502. The screenshot may include game visuals generated on the game window 502. In some instances, the screenshot may exclude the game dashboard overly (e.g., the game dashboard menu 504, the entry point 508, and/or the toolbar 506).

In such an example, a user may initiate the gameplay screenshot feature by interacting with the corresponding tile. When the screenshot is recorded, the corresponding tile may change in appearance. In this regard, the tile may display an indication that a screenshot was taken. The indication may be a change in color, and/or change a displayed message or text. In some instances, the colors (e.g., the original and different color) may be selected by a user. In such an instance, the colors may correspond to the color scheme of the OS of the client computing device. In some instances, the interaction may function as a path to an outside application. The outside application allowing the user to save the screenshot, log into an outside application (e.g., social media) and upload the screenshot thereto, or both. When logging into an outside application, a submenu may be generated. The submenu may be the login form of the outside application.

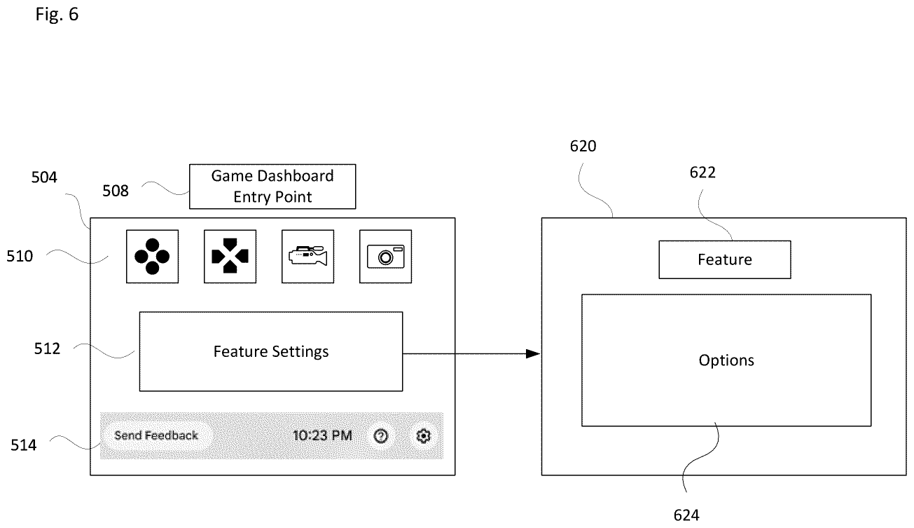

The one or more feature settings 512 may be a list of one or more feature settings corresponding to features of the game dashboard. The one or more features settings 512 may allow a user to toggle features on and off, toggle between different settings of the features, etc. Additionally or alternatively, the listed one or more features settings may open sub-menu that allow for modification of one or more features. FIG. 6 illustrates an example of a sub-menu 620 of a feature of the one or more features settings 512. The sub-menu 620 includes a title and/or description 622 of the feature and one or more options 624 of the feature that may be modified.

In some instances, the modification may include establishing initial settings for features. In some instances, if a feature has not been assigned initial settings, the game dashboard overlay may include an indication (e.g., red dot) on the tile of the feature and/or on a feature setting. In some instances, the modification may involve selecting a mode of the corresponding features. The features of the one or more features settings 512 may correspond to at least one of the features of the one or more tiles 510. The features may include features that are not features of the one or more tiles 510. The features of the one or more feature settings 512 may be common across all game windows including the game dashboard overlay or vary based on underlying game. The features of the one or more feature settings 512 may be modified by, for example a user, to add and subtract desired features.

Like the features of the one or more tiles 510 discussed above, the features of the one or more feature settings 512 may be unique to a game window and underlying game. In one example, features may be relevant to the underlying game of the game window. In some instances, the relevant features may be selected by a user, a game developer, or a combination thereof. Additionally or alternatively, the relevant features may be determined based on the type of game. The type of game may be related to the source of the game, the original intended device of the game, the original intended OS of the game, or any combination thereof. In this regard, the one or more processors of the client computing devices may select or determine what features (e.g., touch compatibility, video record, screenshot, etc.) can be included for a given game.

In one example, a feature setting of the one or more feature settings 512 may be a screen configuration feature. In this regard, upon interacting with the feature setting and opening the corresponding sub-menu 620, a user may select a configuration for the screen. The configurations may include one or more options 624 related to the screen size, screen orientation (e.g., landscape, portrait), and/or the frames per second (fps) of the display. In some instances, the game window may or may not be re-generated following the modification of the screen configuration.

In another example, a feature setting of the one or more feature settings 512 may be a custom control feature. In this regard, upon interacting with the feature setting and opening the corresponding sub-menu 620, a user may select input mappings (e.g., assign user inputs to particular controls of a game). The input mapping selection may be included as one or more options 624. In some instances, the input mapping may include assigning user inputs to controls of the game that were intended for different user inputs (e.g., mapping control intended for a touchscreen to one or more keys of a keyboard).

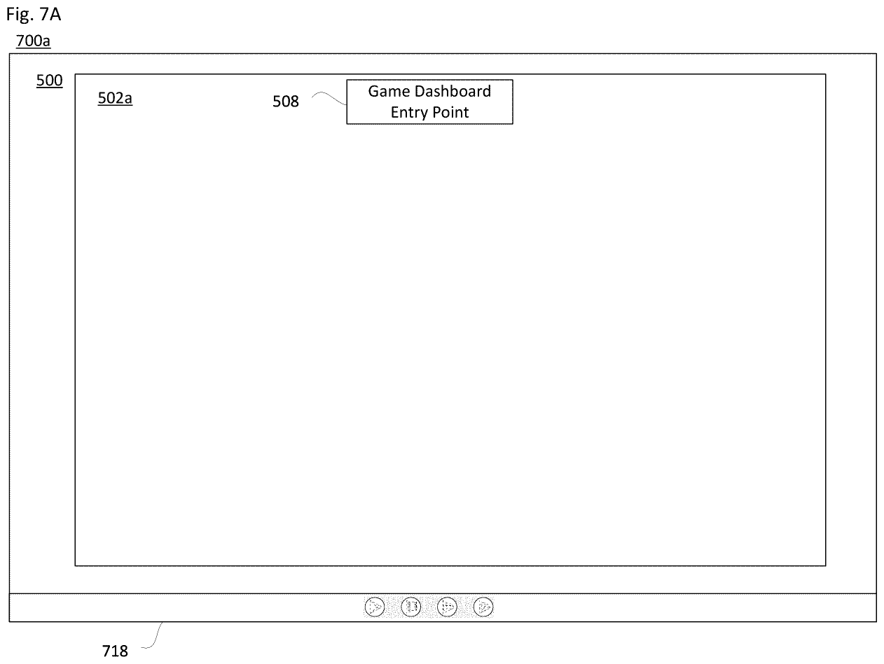

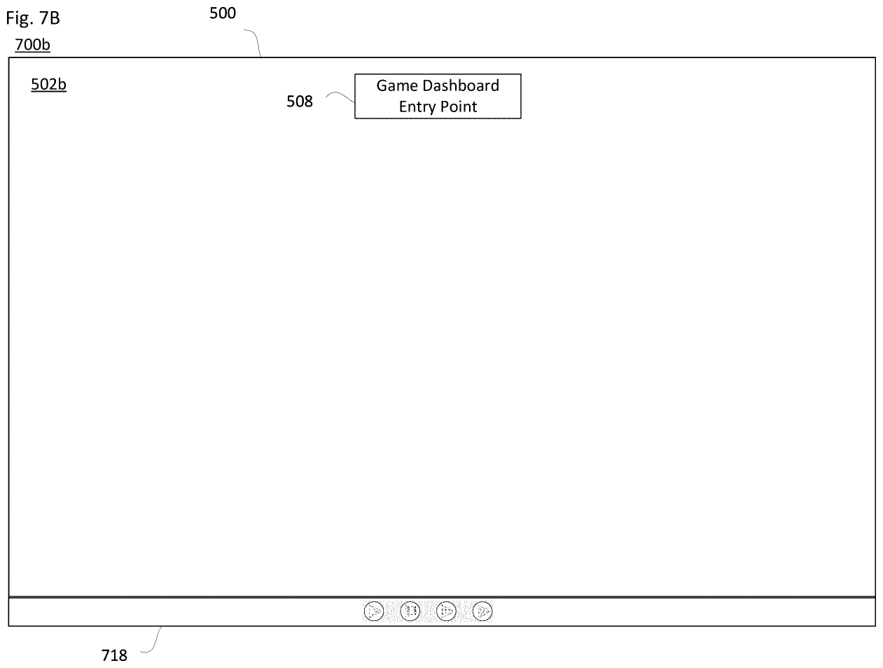

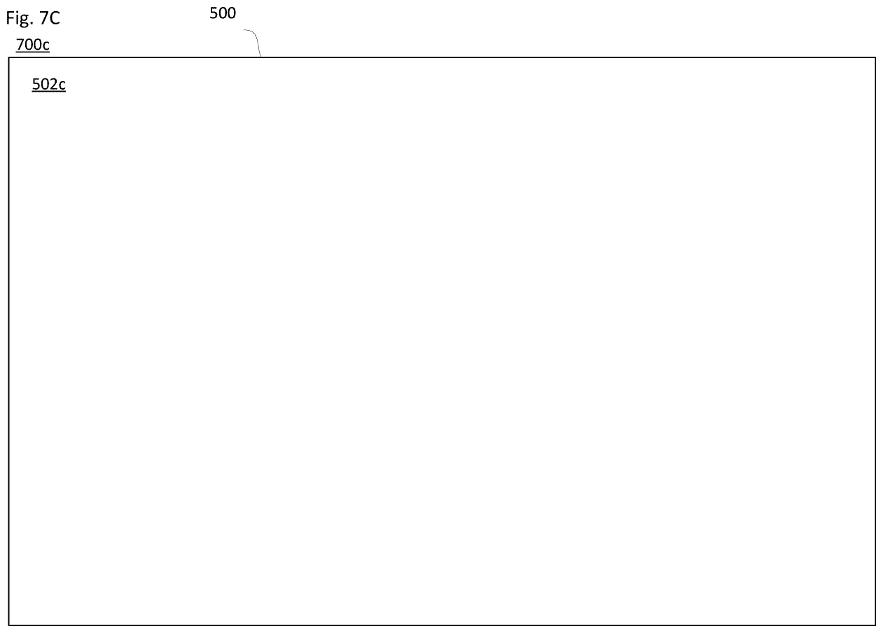

In another example, a feature setting of the one or more feature settings 512 may be a windowing feature. In this regard, upon interacting with the feature setting and opening the corresponding sub-menu 620, a user may select a game window setting. The game window settings may include, for example a windowed setting, a maximized setting, and a fullscreen setting. FIG. 7A illustrates an example 700a of a windowed game window 502a generated on display 500. The windowed view of game window 502a is a reduced game window where other features of the client computing device and display 500 may be accessible. For example, taskbar 718 is viewable and accessible in addition to other portions of display 500. In such an example, the entry point 408 may be visible during gameplay.

FIG. 7B illustrates an example 700b of a maximized game window 502b generated on display 500. The maximized view of game window 502b is an expanded game window view where the game window 502b is generated on as much of the display 500 as possible while still allowing for accessibility of other features of the client computing device and display 500. For example, taskbar 718 is viewable and accessible whereas other portions of the display 500 may not be viewable. In such an example, the entry point 508 may be visible during gameplay.

FIG. 7C illustrates an example 700c of a fullscreen game window 502c generated on display 500. The fullscreen view of game window 502c is an expanded game window view where the game window 502c is generated on the entire display 500. For example, taskbar 718 and other portions of the display 500 may not be viewable or accessible during gameplay. In such an example, the entry point 508 may not be visible during gameplay.

Returning to FIG. 5, the dashboard cluster 514 may include one or more items the user may interact with or provide information thereto. For example, the dashboard cluster 514 may include a feedback option, help option, settings option, and/or a system time (e.g., time consistent with a time zone of the computing device). The feedback option may launch a feedback tool. The feedback option may allow a user to submit feedback on the game, the game dashboard, etc. The help option may launch a help center page. The help center page may provide useful information to the user regarding the game, the game dashboard, etc. The settings option may open a sub-menu. The sub-menu may include settings related to the game dashboard. The settings corresponding to the settings options may alter settings across all game windows including the game dashboard overlay.

The toolbar 506 may allow a user to interact with one or more features, such as those corresponding to the one or more quick actions 516, without pausing and/or leaving game play. The toolbar may be collapsable. In this regard, a user may collapse or make the toolbar smaller by interacting with one of the one or more quick actions 516. In some instances, the toolbar may be collapsed or made smaller when a user interacts with a first action of the one or more quick actions 516. The toolbar 506 may be movable within the game window 502. In this regard, a user may “click and drag” the toolbar 506 via one or more of the user inputs or otherwise move the toolbar 506 via one or more of the user inputs. For example, the one or more user inputs may include a touchscreen. In this regard, the user may tap, hold, and drag the toolbar 506 using the touchscreen or click and drag the toolbar 506 using the touchscreen. In a further example, the user may use one or more keys of a keyboard (e.g., arrow keys; w/a/s/d keys, etc.) to directionally move the toolbar 506.

In some instances, the toolbar 506 may be pinned to a corner of the game window 502. In this regard, the toolbar 506 may be initially generated in a corner of the game window 502. Additionally or alternatively, the toolbar 506 may be pinned to the nearest corner following any movement thereof within the game window 502. Or, alternatively, the toolbar may be allowed to “float” such as an overlay on the GUI. In one example, the display 104 may be divided into four quadrants. Each quadrant may be associated with a corresponding corner of the display 104. In such an example, the toolbar 506 may be pinned or placed in the corner corresponding to the quadrant the tool bar is moved to by the user or otherwise located in.

The one or more quick actions 516 may correspond to the features of the one or more tiles 510 (e.g., include visibility of the toolbar 506, visibility of game controls, gameplay recording, and gameplay screenshot) or one or more feature settings 512 as discussed above. A user may interact with the one or more quick tiles via the one or more user inputs. The interaction may include changing a state or of the feature and/or changing an appearance of the one or more quick actions 516 as discussed above with respect to the one or more tiles 510. The features of the one or more quick actions 516 may be modified by, for example a user, to add and subtract desired features.

Like the features of the one or more tiles 510 and on or more features settings discussed above, the features of the one or more quick actions 516 may be unique to a game window and underlying game. In one example, features may be relevant to the underlying game of the game window. In some instances, the relevant features may be selected by a user, a game developer, or a combination thereof. Additionally or alternatively, the relevant features may be determined based on the type of game. The type of game may be related to the source of the game, the original intended device of the game, the original intended OS of the game, or any combination thereof. In this regard, the one or more processors of the client computing devices may select or determine what features (e.g., touch compatibility, video record, screenshot, etc.) can be included for a given game.

The above systems and methods provide a technical solution that enables a consistent gaming experience for users. In this regard, aspects of the technology allow for functionality of each game to be maintained regardless of a game's original source. The interface disclosed herein provides a single, unified gaming experience for all users. By way of example, this includes a user interface (e.g., game dashboard) that allows a user to access both features specific to each game, along with universally enabled features that support and enable gameplay. This provides a technical benefit by enabling a consistent and supported gaming experience for users without need to play a game on its original intended device or (OS). Such a technical benefit is particularly advantageous for a device and/or OS with no or few native applications or games.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of generating a game dashboard, the method including:
observing, by one or more processors of a client computing device, one or more generated windows on a display of the client computing device, the one or more generated windows corresponding to one or more active applications;
obtaining, by the one or more processors, an indicator corresponding to a window of interest of the one or more generated windows;
determining, by the one or more processors based on the indicator, whether an application corresponding to the window of interest is a game;
generating, by the one or more processors, game dashboard context for the window of interest based on determining that the application corresponding to the window of interest is the game; and
generating, by the one or more processors, the game dashboard as an overlay in the window of interest based on the game dashboard context.

2. The method of claim 1, further comprising determining, by the one or more processors, whether at least one of the one or more generated windows is the window of interest.

3. The method of claim 1, wherein the window of interest is a plurality of windows of interest.

4. The method of claim 1, wherein the indicator is an application identification of an application corresponding to the window of interest, and wherein the application identification is obtained via a string check.

5. The method of claim 1, wherein the indicator is a category of an application corresponding to the window of interest, and wherein the category is obtained from a source of the application corresponding to the window of interest.

6. The method of claim 1, wherein the game dashboard context includes information relevant to the generation of the game dashboard as an overlay, and wherein the game dashboard context is unique to the window of interest.

7. The method of claim 1, wherein the game dashboard includes a toolbar configured to allow a user to interact with one or more features.

8. The method of claim 7, wherein the one or more features are unique to the window of interest.

9. The method of claim 7, wherein the one or more features are selected by at least one of i) a user and ii) an application developer.

10. The method of claim 7, further comprising, determining, by the one or more processors, the one or more features based on the application corresponding to the window of interest.

11. A client computing device comprising:
a display configured to display one or more windows vis a graphical user interface (GUI), the one or more windows corresponding to one or more applications being run by the client computing device; and
one or more processors operatively coupled to the display, the one or more processors configured to:
observe one or more generated windows on the display, the one or more generated windows corresponding to one or more active applications,
obtain an indicator corresponding to a window of interest of the one or more generated windows,
determine, based on the indicator, whether an application corresponding to the window of interest is a game,
generate game dashboard context for the window of interest based on the game determination, and
generate the game dashboard as an overlay in the window of interest based on the game dashboard context.

12. The client computing device of claim 11, wherein the indicator is an application identification of an application corresponding to the window of interest.

13. The client computing device of claim 11, wherein the indicator is a category of an application corresponding to the window of interest, and wherein the category is obtained from a source of the application corresponding to the window of interest.

14. The client computing device of claim 11, wherein the game dashboard includes a toolbar configured to allow a user to interact with one or more features.

15. The client computing device of claim 14, wherein the one or more features are unique to the window of interest.

16. The client computing device of claim 14, wherein the one or more features are selectable by at least one of i) a user and ii) an application developer.

17. The client computing device of claim 11, wherein the game dashboard includes a game dashboard menu, the game dashboard menu including features of the game dashboard.

18. The client computing device of claim 17, wherein the features of the game dashboard include at least one of visibility of portions of the game dashboard or visibility of game controls associated with the game.

19. The client computing device of claim 17, wherein the features of the game dashboard include at least one of a gameplay recording or a gameplay screenshot.

20. A non-transitory computer readable medium having instructions stored thereon, the instructions, when executed by one or more processors of a processing system, implementing a method comprising:
observing, by one or more processors of a client computing device, one or more generated windows on a display of the client computing device, the one or more generated windows corresponding to one or more active applications;
obtaining, by the one or more processors, an indicator corresponding to a window of interest of the one or more generated windows;
determining, by the one or more processors based on the indicator, whether an application corresponding to the window of interest is a game;
generating, by the one or more processors, game dashboard context for the window of interest based on determining whether the application corresponding to the window of interest is the game; and
generating, by the one or more processors, the game dashboard as an overlay in the window of interest based on the game dashboard context.
